(19) United States
(12) Patent Application Publication
(10) Pub. No.: US 2020/0171599 A1
(43) Pub. Date: Jun. 4, 2020

(54) METHOD AND DEVICE FOR CARRYING OUT AND MONITORING A MACHINING PROCESS OF A FIRST WORKPIECE AND A SECOND WORKPIECE BY MEANS OF A HIGH-ENERGY MACHINING BEAM

(71) Applicant: Lessmüller Lasertechnik GmbH, Munchen (DE)

(72) Inventors: Eckhard Lessmueller, München (DE); Christian Truckenbrodt, München (DE); Alexander Denkl, München (DE); Richard Steinbrecht, Stockdorf (DE)

(73) Assignee: Lessmüller Lasertechnik GmbH, München (DE)

(21) Appl. No.: 16/703,693

(22) Filed: Dec. 4, 2019

(30) Foreign Application Priority Data
Dec. 4, 2018 (DE) 10 2018 009 524.0

(51) Int. Cl. B23K 26/03; B23K 26/044

(52) U.S. Cl. CPC B23K 26/032; G01B 9/02091; B23K 26/044

(57) ABSTRACT

A welding method and device for joining first and second workpieces using a high-energy machining beam. The method comprising inserting the first workpiece into a workpiece holder; positioning the second workpiece on a top side of the first workpiece at a target position for joining the workpieces; providing a high-energy machining beam, and focusing the machining beam on a current machining area; generating a measuring beam in an optical coherent tomograph, the measuring beam being coupleable into the machining beam; carrying out a process measurement by the measuring beam in the current machining area during machining of the workpieces; carrying out a control measurement by the measuring beam on at least one of the workpieces; and determining a distance between the first and second workpieces for detecting a gap between the workpieces, based on the result of the control measurement.

### BACKGROUND OF THE INVENTION

The invention relates to a method and a device for carrying out and monitoring a machining process of a first workpiece and a second workpiece by means of a high-energy machining beam. This may be, for example, a welding process for joining the first and second workpieces. Such a device includes a workpiece holder into which at least the first workpiece is insertable, and a machining unit having a machining beam source for generating the high-energy machining beam, which has an optical axis, and including machining beam optics for projecting and/or focusing the high-energy machining beam on a machining area.

### BRIEF SUMMARY OF THE INVENTION

Devices of this type are known from the prior art, and are used in laser material machining processes, for example. A high-energy machining beam in the form of a laser machining beam is used in order to act on one or multiple workpieces or workpiece parts, for example to weld them together in the area of a lap joint, a weld groove, and/or a joint edge.

The device also includes an optical coherent tomograph (OCT) via which a measuring beam, which is coupleable into the machining beam optics, may be generated. The measuring beam may be deflectable via a deflection unit. The deflection unit may be movable. The machining processes may thus be monitored in three dimensions in that, in addition to customary two-dimensional monitoring by cameras or the like, the coherent tomograph is used to allow a depth measurement during the machining process.

A method is known from DE 10 2013 015 656 A1 that allows measurement of the penetration depth of a laser beam into a workpiece, using an optical coherent tomograph. A first measuring beam is used to determine a distance between a reference point and a workpiece surface, while a second measuring beam is directed into the keyhole (vapor capillary) of the current weld point. The measurement using the second measuring beam allows a distance between the reference point and a measuring point inside the keyhole to be determined. The penetration depth of the laser beam is deduced based on the determined distances.

For the case of superposed workpieces, for example metal sheets to be welded, the situation may arise that the metal sheets do not lie flat on top of one another along the entire contact surface or along the entire weld seam, and instead, in places a gap is formed between the workpieces. This gap may result from inaccuracies caused by forming processes for the workpieces, or from imprecisely adjusted workpiece clamps that unintentionally deform the workpieces in certain areas. Such a gap impairs the quality of the weld seam. As the result of a large gap, for example, it is possible that the workpieces cannot be welded in the area of the gap, or that the weld seam is situated only in the upper workpiece. On the other hand, if the machining time is increased for machining both workpieces, also in the case of a gap, this may possibly result in an excessively large weld depth, so that the lower workpiece may also be melted on its bottom side. This may damage a corrosion protection layer, for example a zinc layer, that is present on the lower workpiece, resulting in susceptibility to corrosion in the area of such a weld seam.

If such a gap is present in an interior area of the workpieces, it is not detectable from the outside. However, since when a gap is present it is not clear whether the workpieces are reliably joined in a damage-free manner, detecting gaps is of great importance for the user.

Gap detection based on real-time OCT depth measurement is proposed in the article “Inline monitoring of laser processing: new industrial results with the low coherence interferometry sensor approach” by Kogel-Hollacher et al. (DOI: 10.1117/12.2208004). An OCT depth measurement is carried out during the welding process. A gap that is present is detectable based on a jump and a plateau in the time-machining depth diagram, which occur when, after penetration of the upper workpiece, the machining beam initially passes through the gap relatively unhindered, and then begins to melt the top side of the lower workpiece.

In addition, as discussed in the article “Keyhole Depth is just a Distance” by Bautze and Kogel-Hollacher (DOI: 10.1002/latj.201400040), for superposed workpieces, welding through two workpieces may be detected by a temporally resolved weld depth measurement, even when a gap is present between the workpieces, when the penetrated bottom side of the lower workpiece results in sufficient back reflection, so that after the penetration a corresponding depth signal may be obtained from the interferogram. However, it has been shown that automated detection of the gap based on the temporal depth profile is difficult, since a gap must be detected with high reliability in order to avoid manufacturing defective or damaged parts. In addition, it has been shown that the appearance of a jump or a plateau in the temporal depth profile is strongly dependent on the particular application, the machining parameters, and the workpieces.

The object of the present invention is to provide a device and a method of the type stated at the outset which allow simple and reliable detection of gaps.

This object is achieved according to the invention by a method for carrying out and monitoring a machining process of a first workpiece and a second workpiece for joining the first and second workpieces using a high-energy machining beam, wherein the method comprises the steps of inserting the first workpiece into a workpiece holder; positioning the second workpiece on a top side of the first workpiece at a target position for joining the workpieces; providing a high-energy machining beam that has an optical axis, and projecting the machining beam on a current machining area; generating a measuring beam in at least one optical coherent tomograph, the measuring beam being coupleable into the machining beam; carrying out a process measurement using the measuring beam in the current machining area during machining of the workpieces using the machining beam; carrying out a control measurement using the measuring beam on at least a portion of at least one of the workpieces; and determining a distance between the first workpiece and the second workpiece for detecting a gap that is possibly present between the workpieces, based on the result of the control measurement. This object is also achieved according to the invention by a method for manufacturing a workpiece for use in a method for carrying out and monitoring a machining process of a first workpiece and a second workpiece for joining the first and second workpieces using a high-energy machining beam, as disclosed above, which workpiece is configured to be joined to another workpiece along a joining seam using a high-energy machining beam. The method for manufacturing comprising the steps of producing a workpiece blank; and providing the workpiece blank with multiple holes along a course that a future joining seam is to follow.

In one embodiment, the process measurement and the control measurement are carried out by the same coherent tomograph. In another embodiment, the method comprises the further step of carrying out the control measurement, using the optical coherent tomograph, at least in part during the machining of the workpieces. In another embodiment, a predefined thickness of the first workpiece and a predefined thickness of the second workpiece are used for determining the distance between the first workpiece and the second workpiece. In another embodiment, the control measurement includes at least one determination of the position of the workpiece holder, the control measurement being carried out, at least in part, before the first workpiece is inserted. In another embodiment, the control measurement includes at least one measurement on the top side of the first workpiece in a state in which the second workpiece is at the target position. In another embodiment, at least a portion of the control measurement, on the top side of the first workpiece a measuring beam is at least partially guided through a hole in the second workpiece that is provided in the second workpiece independently of the machining of the workpieces. In another embodiment, the hole in the second workpiece is welded closed on the top side of the first workpiece after the measurement. In another embodiment, for the control measurement, at least one test machining of the workpieces that is different from the machining of the workpieces is carried out. In another embodiment, the test machining takes place through both workpieces in such a way that a bottom side of the first workpiece is penetrated at certain points. In another embodiment, after the test machining, an area in which the test machining has been carried out is welded closed using the machining beam. In another embodiment, the machining of the workpieces and the test machining are carried out using machining beams that have different beam diameters. In another embodiment, a switchable fiber is used for generating the machining beams for the test machining and for the machining of the workpieces. In yet another embodiment, for the control measurement, at least one measurement is carried out on a bottom side of the first workpiece. In still another embodiment, for the measurement on the bottom side of the first workpiece, a measuring beam is deflected on at least a portion of the workpiece holder by use of a reflective element.

This object is also achieved according to the invention by a device for carrying out and monitoring a machining process of a first workpiece and a second workpiece for joining the first and second workpieces using a high-energy machining beam, wherein the device comprises a workpiece holder into which at least the first workpiece is insertable; a machining unit having a machining beam source for generating the high-energy machining beam, which has an optical axis, and including machining beam optics for projecting the high-energy machining beam on a current machining area, and at least one optical coherent tomograph for generating a measuring beam that is coupleable into the machining beam optics. The device is configured in an inserted state of the first workpiece in which the second workpiece is positioned on a top side of the first workpiece at a target position for machining the workpieces, to carry out at least one process measurement using the measuring beam during machining of the workpieces using the machining beam; to carry out a control measurement using the measuring beam on at least a portion of at least one of the workpieces; and to determine a distance between the first workpiece and the second workpiece, based on the result of the control measurement, in order to detect a gap that is possibly present between the workpieces. In one embodiment, the machining unit has a switchable fiber through which a beam diameter of the machining beam may be changed. In yet another embodiment, the device further comprises a control unit that is configured to determine the distance between the first workpiece and the second workpiece based on the result of the control measurement and based on a predefinable thickness of the first workpiece and a predefinable thickness of the second workpiece. In still another embodiment, the workpiece holder includes at least one reflective element through which the measuring beam may be directed onto a bottom side of the first workpiece.

According to the invention, a method for carrying out and monitoring a machining process of a first workpiece and a second workpiece, in particular a welding process for joining the first and second workpieces by means of a high-energy machining beam, comprises the steps:
inserting the first workpiece into a workpiece holder;
positioning the second workpiece on a top side of the first workpiece at a target position for joining the workpieces;
providing a high-energy machining beam that has an optical axis, and projecting and/or focusing the machining beam on a current machining area;
generating a measuring beam in at least one optical coherent tomograph, the measuring beam being coupleable into the machining beam;
carrying out a process measurement by means of the measuring beam in the current machining area during machining of the workpieces by means of the machining beam;
carrying out a control measurement by means of the measuring beam on at least a portion of at least one of the workpieces; and
determining a distance between the first workpiece and the second workpiece for detecting a gap that is possibly present between the workpieces, based on the result of the control measurement.

In addition, a device according to the invention of the type stated at the outset and in particular at least one control unit of this device are configured:
in an inserted state of the first workpiece in which the second workpiece is positioned on a top side of the first workpiece at a target position for machining the workpieces, to carry out at least one process measurement by means of the measuring beam during machining of the workpieces by means of the machining beam;
to carry out a control measurement by means of the measuring beam on at least a portion of at least one of the workpieces; and
to determine a distance between the first workpiece and the second workpiece, based on the result of the control measurement, in order to detect a gap that is possibly present between the workpieces.

The method may be carried out using the device. In particular, the device is configured to carry out the method in a partially automated or automated manner.

The measuring beam may be deflectable via a deflection unit. The deflection unit may be movable. The device may correspondingly have an in particular movable deflection unit. Alternatively, the deflection unit may have an immovable design. In addition, it is possible according to the invention to couple the measuring beam into the machining beam without an additional deflection unit, for example via a suitable arrangement of the optical coherent tomograph.

According to the invention, an additional control measurement may be used to determine a distance between the workpieces, as the result of which the presence of a gap between the workpieces may be determined. Since an additional measurement is used for the determination, such a gap may be reliably detected, in particular more reliably than when the presence of a gap is indirectly deduced solely from the process measurement, as explained at the outset with regard to the prior art. Thus, during the machining process it may be detected if an excessively large gap is formed in places between the workpieces, which would adversely affect secure welding of the workpieces.

The insertion into the workpiece holder may take place in a suitable manner, and may encompass, for example, bracing, fixing, clamping, aligning, insetting, or the like.

The target position of the first workpiece corresponds, for example, to a position relative to the second workpiece at which the first workpiece is to be situated after the workpieces are welded, wherein the joined workpieces together may form a component and/or a part. The target position may be maintained over the entire machining process for joining the workpieces.

The process measurement may be a monitoring measurement that is carried out in the current machining area while the machining beam strikes at least one of the workpieces in order to machine the workpieces. The process measurement includes, for example, directing the measuring beam onto a keyhole that forms during the machining with the machining beam to allow monitoring of the machining process that is underway. The process measurement may also include measurement at different points of the current machining area, as described in DE 10 2016 014 564 A1. The process measurement is used in particular for monitoring the actual machining process, for which purpose measuring information, which may be obtained during the machining at measuring points inside the keyhole as well as at measuring points that differ from the keyhole, may be used.

The position of the keyhole relative to an instantaneous point of incidence of the machining beam on the workpieces may be a function of the feed speed, machining direction, machining power, material, workpiece composition, workpiece thickness, gap size, diameter of the machining beam, etc. If at least one of these parameters changes, it may be necessary to adjust the position of incidence of the measuring beam with respect to the machining beam. This applies in particular to the process measurement, but alternatively or additionally may be relevant for the control measurement. The keyhole is typically longer in the feed direction when the lower workpiece is not attached to the upper workpiece, for example in the case of a large gap between the workpieces.

The control measurement is different from the process measurement. The control measurement may include multiple partial and/or individual measurements. Partial and/or individual measurements of the control measurements may be carried out at different times before and/or during the machining. In addition, different partial and/or individual measurements may be carried out at different positions and/or on different objects. The distance between the workpieces is preferably determined for the current machining area; the distance between the workpieces may be a function of a position relative to the workpieces positioned one on top of the other, for example when a gap, possibly with a variable gap thickness, is formed between the workpieces in places. The process measurement may be carried out in an automated manner. In addition, the control measurement and/or the determination of the distance may be carried out in an automated manner. It is possible according to the invention for at least one piece of information to be output for a user if the distance exceeds a limit value, for example to indicate the presence of a gap and/or its position or pattern. The distance may be determined based on the result of the control measurement and also based on a result of the process measurement.

According to one refinement, the process measurement and the control measurement are carried out by the same coherent tomograph. Thus, no additional components are necessary, and an existing coherent tomograph may be used for carrying out the control measurement.

Alternatively, the device may include at least two coherent tomographs, one of which is usable, for example, for carrying out the process measurement, and one for carrying out the control measurement.

Checking for possibly present gaps in real time, which may also allow a position of the gap to be determined, may be achieved in particular when the control measurement using the optical coherent tomograph is carried out, at least in part, during the machining of the workpieces. At least one partial and/or individual measurement of the control measurement in a certain area may, for example, precede, for example directly precede, machining in this area. For this purpose, the measuring beam may be deflected, at least temporarily, relative to the machining beam. For example, the measuring beam for carrying out the process measurement may be temporarily directed into the current machining area and temporarily directed out of the machining area in order to carry out at least a portion of the control measurement, for example in an area that forms a subsequent machining area. A gap in an area of the workpieces may thus be detected before machining takes place in this area. It is then possible to stop the machining operation or change welding parameters in such a way that secure welding is ensured in order to prevent faulty joining of the workpieces.

In addition, it may be provided that a predefined thickness of the first workpiece and a predefined thickness of the second workpiece are used for determining the distance between the first workpiece and the second workpiece. For this purpose, the control unit of the device may be configured to receive predefinable values for the thickness of the first workpiece and/or for the thickness of the second workpiece. These values may be predefinable, for example, by a user via a user interface. Alternatively or additionally, the device or the control unit may be configured to determine at least one of the thicknesses in an automated manner. This may take place, for example, by a direct measurement of the thickness in question, or by retrieving stored values, which takes place based on detection of the workpieces and/or according to a user input. In particular in the case of formed sheet metal sections, a sheet thickness may be assumed to be constant. It is then possible to assume constant and/or known thicknesses for structurally identical workpieces, even if no direct measurement has been performed for individual workpieces.

In one embodiment, the control measurement includes at least one determination of the position of the workpiece holder, the control measurement being carried out, at least in part, before the first workpiece is inserted. Such a control measurement or such a partial and/or individual measurement of the control measurement may take place, for example, a single time prior to machining a series of workpieces, at uniform intervals, or prior to inserting each new workpiece. For example, by means of the measuring beam a distance, for example starting from a reference point, from a contact surface of the workpiece holder on which the first workpiece is laid is determined. Assuming that the first workpiece lies flat on the contact surface and that the thickness of the first workpiece is known, in this case a position of a top side of the first workpiece may be easily deduced, since in this case the distance of this top side from the contact surface is the magnitude of the thickness of the first workpiece. If a position of a top side of the second workpiece is also determined by means of a further partial and/or individual measurement of the control measurement, a distance between the contact surface and the top side of the second workpiece or between the bottom side of the first workpiece and the top side of the second workpiece may be calculated. The measurement of the top side of the second workpiece may then take place during the machining of the workpieces, for example in or in front of the current machining area. The determined distance may be compared to the predefined and/or measured thicknesses of the workpieces, wherein for the case that a gap is present between the workpieces, the calculated distance is greater than the sum of the thicknesses.

In one refinement, the control measurement includes at least one measurement on the top side of the first workpiece. In this way a position, in particular an elevation, of the top side of the first workpiece may be determined so that a distance from a reference point to the top side of the first workpiece may be determined, even for the case that the first workpiece does not lie flat on the workpiece holder. This distance may be compared to the determined position of the workpiece holder, using the predefined thickness of the first workpiece, for example to detect faulty mounting and/or clamping of the first workpiece.

The measurement on the top side of the first workpiece is preferably carried out in a state in which the second workpiece is situated at the target position. It may thus be ensured that the first workpiece does not subsequently shift due to clamping or mounting of the second workpiece, resulting in incorrect measured values. For example, for the measurement the measuring beam may be guided onto the first workpiece when the first workpiece is in the vicinity of the weld point and is exposed within the visual range of the machining optics. This is possible, for example, for machining operations in the edge area of the second workpiece or through notches that are present in the second workpiece. For this purpose, the closest notch to the current machining area may be selected so that during the machining, multiple measurements are carried out on the top side of the first workpiece and multiple measurements are carried out on the top side of the second workpiece, on the basis of which a distance between the top side of the first workpiece and the top side of the second workpiece may be determined in each case. This distance may be compared to the predefined thickness of the second workpiece to allow a conclusion to be drawn that a gap is present, for example in the current machining area or in its vicinity. In addition, a conclusion may be drawn concerning the pattern of such a gap by determining the distance as a function of location.

Alternatively or additionally, for at least a portion of the control measurement, on the top side of the first workpiece the measuring beam may be at least partially guided through a hole in the second workpiece that is provided in the second workpiece independently of the machining of the workpieces. The hole is preferably situated in a future machining area. The hole may be welded closed on the top side of the first workpiece after the measurement. A position of the top side of the first workpiece may be determined for a future machining area. If a position of the top side of the second workpiece is additionally determined for this machining area, for example when this machining area is the current machining area, once again a gap that is possibly present may be detected by comparing the distance between the top sides to the thickness of the second workpiece.

According to the invention, it is possible for the second workpiece to be provided with multiple holes along a course that a future joining seam is to follow. These holes may be arranged at uniform intervals and/or may extend perpendicularly with respect to a surface normal of the second workpiece, so that a measuring beam with perpendicular incidence may pass through. For example, the holes may be created during manufacture of the second workpiece or directly before machining the workpieces. The machining unit may also be used for this purpose.

Thus, the invention also encompasses a method for manufacturing a workpiece for use in the method according to the invention for carrying out and monitoring a machining process. The second workpiece in particular is manufactured in this manufacturing method. In a first step a workpiece blank is produced, which in a second step is provided with multiple holes along a course that a future joining seam is to follow. Any suitable production methods, such as punching, drilling, laser machining, or the like may be considered for creating the holes.

According to one embodiment, for the control measurement at least one test machining of the workpieces that is different from the machining of the workpieces is carried out. The machining unit may be used for this purpose. At least one partial and/or individual measurement of the control measurement may be carried out during the test machining, for example by guiding the measuring beam in parallel to the machining beam while the machining beam is carrying out the test machining. The test machining may be carried out, for example, in a future machining area and/or in front of the current machining area. In particular, after the test machining an area in which the test machining has been carried out is welded closed by means of the machining beam.

The workpieces may be measured with high precision and accuracy in particular when the test machining takes place through both workpieces in such a way that a bottom side of the first workpiece is penetrated at certain points. The test machining is preferably ended as soon as the bottom side of the first workpiece is penetrated. Damage to a corrosion protection layer on the bottom side of the first workpiece may be minimized in this way.

If the test machining is accompanied by an OCT measurement within the scope of the control measurement, a temporal depth profile may be obtained for the test machining. As mentioned at the outset, at least one position of the bottom side of the first workpiece may be recognized very reliably in this way. In addition, a position of the top side of the second workpiece may likewise be reliably recognized. The test machining allows a distance between the bottom side of the first workpiece and a top side of the second workpiece to be determined with high reliability and accuracy. The presence of a gap may be reliably deduced by comparing this distance to the sum of the thicknesses of the workpieces. In addition, the distance between the workpieces may be determined with high accuracy.

A high level of reliability and accuracy in combination with minimal effects on a corrosion protection layer may be achieved in particular when the machining of the workpieces and the test machining are carried out using machining beams that have different beam diameters. The test machining is preferably carried out using a machining beam having a smaller beam diameter than for the machining for joining the workpieces. Due to the high sensitivity and precision of an OCT measurement, even holes having a small diameter are sufficient to allow a measurement to be carried out by means of the measuring beam. The diameter of the machining beam may therefore be reduced, for example, at least by a factor of 2, at least by a factor of 3, or even at least by a factor of 4.

According to one embodiment, the machining unit has a switchable fiber by means of which a beam diameter of the machining beam may be changed. For example, the light for generating the machining beam may be guided through the sheath of the switchable fiber for machining the workpieces, but guided through the core of the fiber for the test machining. In this way, a switch between a diameter of 200 μm and a diameter of 50 μm, for example, may be made, with any other given values and factors being possible. The switchable fiber may be operated, for example, according to the procedure, or at least portions thereof, described in WO 2011/124671 A1.

The control measurement may include at least one measurement on a bottom side of the first workpiece. This may be a measurement that is carried out within the scope of the test machining. In this measurement, the measuring beam may be directed from a top side of the second workpiece onto the area of the test machining, for example to penetrate into the keyhole for the test machining.

Alternatively or additionally, for the measurement on the bottom side of the first workpiece, a measuring beam may be deflected on at least a portion of the workpiece holder by use of a reflective element. The workpiece holder thus has at least one reflective element in this case. The measuring beam may be guided around the workpieces on the bottom side of the first workpiece. This may take place even without test machining, as the result of which damage to the corrosion protection layer may be completely avoided. According to one embodiment, by means of the reflective elements the measuring beam may be guided at different points on the bottom side of the first workpiece, which, for example, are situated opposite from the current machining area or a future machining area. At least one of the reflective elements of the workpiece holder may have a movable design, and in particular may be movable in an automated manner, to allow deflection of the measuring beam in a targeted manner. However, a deflection may also be carried out by selecting a suitable incidence angle, wherein the reflective elements are immovable. If a partial and/or individual measurement is additionally carried out on the top side of the second workpiece, once again the distance between the top side of the second workpiece and the bottom side of the first workpiece may be determined for various points, for example along a course of a joining seam. In this case, comparison to the sum of the thicknesses of the workpieces allows a conclusion to be drawn concerning the presence of a gap between the workpieces.

It may also be optionally provided to use a second coherent tomograph, which is arranged in such a way that its measuring beam may be directed onto the bottom side of the first workpiece.

As discussed above in conjunction with various aspects of the invention, the control measurement may include different measurements or partial and/or individual measurements, which in part allow conclusions concerning the presence of a gap to be drawn independently of one another. The invention encompasses methods and devices in which one of the described aspects is used, as well as methods and devices in which several of the described aspects are used. In particular, it may optionally be provided that the distance between the workpieces is determined in more than one way or based on the results of multiple measurements carried out within the scope of the control measurement, so that, for example, a plausibility check for the determined distances is made possible.

Machining may be aborted if the presence of a gap is detected and/or the size of the gap or the distance between the workpieces is determined. In addition, it is possible according to the invention for machining to take place with adjustment of the machining power, machining time, or other machining parameters. For example, if the gap is small enough to still allow reliable joining of the workpieces, an adjustment may be made in such a way that the gap is bridged by melted, solidified material, but welding through the first workpiece is avoided. Information concerning the gap may also be output for a user who, for example, conducts a final inspection and/or decides whether a finished part must be classified as defective.

It is understood that the subject matter of the invention is not limited to the embodiments described above. The described embodiments and features may be arbitrarily combined by those skilled in the art without departing from the subject matter of the invention.

### BRIEF DESCRIPTION OF THE SEVERAL VIEWS OF THE DRAWINGS

Preferred embodiments of the invention are explained in greater detail below with reference to the appended schematic drawings, which show the following:

FIG. 1 shows a schematic overall view of a first exemplary embodiment of a device according to the invention for carrying out a machining process of a first workpiece and a second workpiece;

FIG. 2 shows a schematic sectional illustration of the two workpieces in a joined state, in an area without a gap between the workpieces;

FIG. 3 shows a schematic sectional illustration of the two workpieces in an area in which a gap is present between the workpieces;

FIG. 4 shows a schematic top view of the two workpieces during machining, in which a measurement is carried out on a top side of the first workpiece according to one aspect of the invention;

FIG. 5 shows a schematic top view of the two workpieces during machining, in which a measurement is carried out on a top side of the first workpiece according to a further aspect of the invention;

FIG. 6 shows a schematic illustration for depicting test machining according to one aspect of the invention;

FIG. 7 shows a schematic temporal depth profile for the test machining, which results from a measurement of a control measurement during the test machining;

FIG. 8 shows a workpiece holder according to one aspect of the invention that is provided with reflective elements; and

FIG. 9 shows a schematic flow chart of one exemplary embodiment of a method according to the invention for carrying out and monitoring a machining process of a first workpiece and a second workpiece.

### DETAILED DESCRIPTION OF THE INVENTION

Multiple aspects of the invention are described below. Different procedures for gap detection, distance determination, and carrying out machining, test machining, process measurements, and control measurements are described. These procedures may be implemented in different embodiments of the invention. Likewise, some or all of these aspects may be implemented in a single embodiment, and may be applied alternatively or in addition to one another, for example for purposes of a plausibility check or for a user selection of the type of gap detection. In particular, a device according to the invention is suitable for implementing multiple aspects of the method.

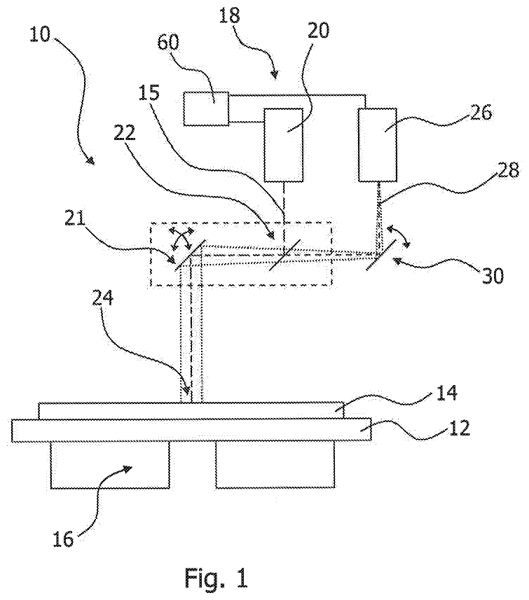

FIG. 1 shows a schematic overall view of one embodiment of a device 10 according to the invention for carrying out a machining process of a first workpiece 12 and a second workpiece 14. The machining process is a welding process for joining the first workpiece 12 and the second workpiece 14 by means of a high-energy machining beam 15, in the present case, a laser beam. The workpieces 12, 14 in the present case are sheet metal parts. However, any workpieces that can be joined by means of the machining beam are possible according to the invention.

The device 10 includes a workpiece holder 16 into which the workpieces 12, 14 are appropriately inserted. The device 10 also includes a machining unit 18 having a machining beam source 20 that generates the high-energy machining beam 15. The machining unit 18 includes machining beam optics 22, only schematically illustrated, by means of which the machining beam 15 may be projected and/or focused on a current machining area 24. A joining seam for joining the workpieces 12, 14 along a predetermined course may be produced in a manner known per se by appropriate relative movement between the machining beam 15 and the workpieces 12, 14, for example by appropriately advancing the workpieces 12, 14 and/or by moving the machining beam optics 22 and/or an optical element of the machining beam optics 22 and/or of the machining unit 18.

The device 10 also includes an optical coherent tomograph 26 having a known design, by means of which a measuring beam 28, which is coupleable into the machining optics 22 via a deflection unit 30, likewise only schematically illustrated, and guidable onto the workpieces 12, 14, may be generated. In a known manner the coherent tomograph 26 has a suitable light source, for example a superluminescent diode, and a measuring arm and a reference arm. Distances relative to a reference point may be determined by means of an interferometer of the optical coherent tomograph 26.

The measuring beam 28 and the machining beam 15 may be displaced in such a way that they coincide. However, the measuring beam 28 is displaceable independently of the machining beam 15, so that the machining beam 15 and the measuring beam 28 may meet at different locations on the workpieces 12, 14. This is schematically illustrated by the dotted lines in FIG. 1.

The device 10 also has a control unit 60 that is configured to automatically control the machining unit 18 and the optical coherent tomograph 26. The device 10 also has a user interface, not illustrated, via which information may be input and output.

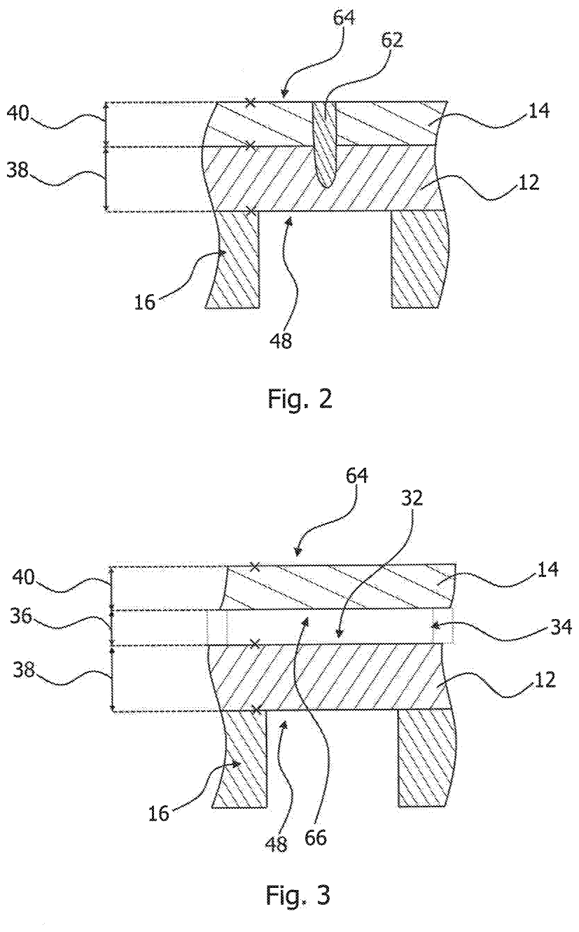

FIG. 2 shows a schematic sectional illustration of the two workpieces 12, 14 in a joined state. The first workpiece 12 is inserted into the workpiece holder 16 prior to machining. The second workpiece 14 is placed at a target position on the first workpiece 12. In the superposed state, machining then takes place by means of the machining beam 15, via which a joining point 62 is produced. The joining point forms a section of a joining seam between the workpieces 12, 14.

FIG. 2 illustrates an area of the workpieces 12, 14 in which the workpieces 12, 14 lie directly on top of one another, so that no gap is formed between them. This represents the desired case in which the workpieces 12, 14 may be reliably joined. When the machining beam 15 is projected onto the top side 64 of the second workpiece 14, in the machining area 24 (see FIG. 1) first the second workpiece 14 on top melts, followed by the first workpiece 12 situated underneath, wherein a melt is formed that extends in both workpieces 12, 14 and joins them. When the machining beam 15 is advanced or switched off, the molten material of the workpieces 12, 14 solidifies and forms the joining point 62. If the workpieces 12, 14 are superposed in an area of the joining point 62 without a gap, the sum of a thickness 38 of the first workpiece 12 and a thickness 40 of the second workpiece 14 corresponds to a distance between oppositely situated points on the top side 64 of the second workpiece 14 and a bottom side 48 of the first workpiece 12. Such points are marked by crosses in FIG. 2.

However, due in particular to deformations in the workpieces 12, 14, a gap 34 may form, at least in places, between the workpieces 12, 14, as schematically illustrated in FIG. 3. The workpieces 12, 14 are then situated at a distance 36 from one another that corresponds to a distance between a bottom side 66 of the second workpiece 14 and a top side 32 of the first workpiece 12. Consequently, a distance between the mentioned points on the top side 64 of the second workpiece and the bottom side 48 of the first workpiece 12 is greater, by this distance 36, than the sum of the thicknesses 38, 40 of the workpieces 12, 14.

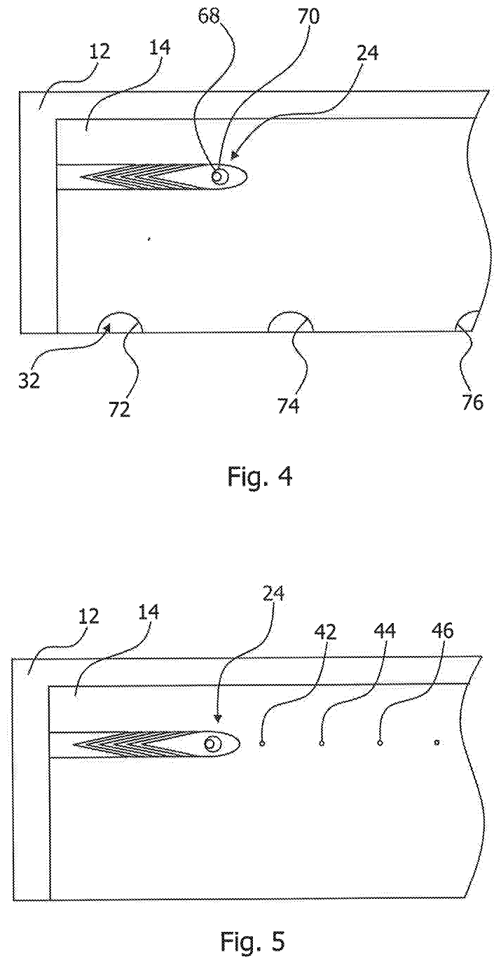

The device 10 is configured to carry out a process measurement by means of the measuring beam 28 during the machining of the workpieces 12, 14. This process measurement takes place, for example, by guiding the measuring beam 28 into a keyhole 68 that is formed in the current machining area 24 during the machining (see FIG. 4). The keyhole 68 is typically formed just behind, based on the machining direction, an impingement area 70 of the machining beam 15 in the current machining area 24.

In addition, the device 10 is configured to carry out a control measurement, which is different from the process measurement, by means of the measuring beam 28. In the present case, the control measurement is carried out by means of the optical coherent tomograph 26. The control measurement is at least partially carried out during the machining of the workpieces 12, 14. In addition, the control unit 60 carries out a control of the control measurement.

Based on a result of the control measurement, a gap 34 that is possibly present between the workpieces 12, 14 is then detected. In addition, the control measurement encompasses multiple measurements at different locations. The presence of a gap 34 is subsequently carried out for the current machining area 24; i.e., the control measurement is carried out in such a way that for the current machining area 24 it may be determined whether a gap 34 is present between the workpieces 12, 14 in this area, or the workpieces 12, 14 lie directly one on top of the other. In addition, the distance 36 between the workpieces 12, 14 is determined, so that a conclusion may be drawn concerning a dimension of the gap 34 and a likely result of machining in the current machining area 24. The determination of the distance 36 or the presence of a gap 34 is carried out automatically by the control unit 60, based on the control measurement.

According to one aspect, the control measurement includes a measurement of a distance from a reference point to a point on the top side 64 of the second workpiece 14. This measurement is carried out, for example, by briefly interrupting the process measurement during the machining and moving the measuring beam 28 forward in the machining direction, as indicated by the dotted line in FIG. 1. The measurement then takes place, for example, in the next machining area before the second workpiece 14 is machined in that area.

Furthermore, the control measurement includes a measurement that allows a conclusion to be drawn concerning a position of the bottom side 48 of the first workpiece 12. According to one aspect, for this purpose a position of the workpiece holder 16 is determined by means of the measuring beam 28 before the workpieces 12, 14 are inserted. In addition, predefined values for the thicknesses 38, 40 of the workpieces 12, 14 are used. Assuming that the first workpiece 12 lies flat on the workpiece holder 16, a distance 36 between a measuring point in question on the workpiece holder 16 and a corresponding measuring point on the top side 64 of the second workpiece 14 corresponds to the distance 36 between the above-mentioned oppositely situated points on the bottom side 48 of the first workpiece 12 and the top side 64 of the second workpiece 14. The measuring points are illustrated by crosses in FIGS. 2 and 3 by way of example. If the distance 36 differs from a sum of the thicknesses 38, 40 of the workpieces 12, 14, the presence of a gap 34 is deduced. In addition, the distance 36 and thus the thickness of the gap 34 may be determined. The measurement on the workpiece holder 16 may include multiple measuring points, for example according to a future and/or planned course of a joining seam.

According to another aspect, within the scope of the control measurement at least one measurement is additionally or alternatively carried out on the top side 32 of the first workpiece 12 by means of the measuring beam 28. This measurement is carried out after the first workpiece 12 is inserted and before the second workpiece 14 is inserted. In combination with the measurement on the top side of the second workpiece 14, based on a distance between a measuring point on the top side 32 of the first workpiece 12 and a measuring point on the top side 64 of the second workpiece 14, the presence of a gap may be deduced by comparing the stated distance to the known thickness 40 of the second workpiece 14. If the distance is greater than the thickness 40 of the second workpiece 14, on this basis the distance 36 between the workpieces 12, 14 may be determined as the difference between the distance between the measuring points and the thickness 40. In addition, the presence of a gap 34 may be deduced. The measuring points are illustrated by crosses in FIGS. 2 and 3 by way of example. The measurement on the top side 32 of the first workpiece 12 may include multiple measuring points, for example according to a future and/or planned course of a joining seam.

FIG. 4 illustrates a further aspect of the method according to the invention. Within the scope of the control measurement, a measurement is carried out on the top side 64 of the first workpiece 12 when the second workpiece 14 is already at the target position. In the illustrated case, the second workpiece has multiple notches 72, 74, 76, which due to a geometry of the second workpiece 14 and/or due to a target geometry of the finished component or the finished part are present independently of the control measurement or independently of the machining of the workpieces 12, 14. For the control measurement, the measuring beam 28 is temporarily directed onto at least one of the notches 72, 74, 76 and is guided through same onto the top side 32 of the first workpiece 12. In addition, as described above, a measurement is carried out on the top side 64 of the second workpiece 14. This takes place either during the machining by deflection of the deflection unit 30 (OCT scanner), or with a brief interruption of the machining by deflection of a machining scanner 21 of the machining beam optics 22. Analogously to the aspect described above, a distance between corresponding measuring points may then be compared to a known thickness 40 of the second workpiece 14. A notch 72, 74, 76 is advantageously selected in each case that is closest to the future machining area in which the top side 64 of the second workpiece 14 is measured, in order to form pairs of measuring points.

According to yet another aspect, for which reference is made to FIG. 5, the second workpiece 14 is provided with multiple holes 42, 44, 46 that are provided in the second workpiece 14 independently of the machining of the workpieces 12, 14. According to the invention, for manufacturing the second workpiece 14, for this purpose a suitable workpiece blank is provided with multiple holes 42, 44, 46 along a course that a future joining seam is to follow.

Within the scope of the control measurement, in an inserted and positioned state of the workpieces 12, 14 the measuring beam 28 may then be guided through one of the holes 42, 44, 46 in each case in order to once again carry out a measurement on the top side 32 of the first workpiece 12. For this purpose, the measuring beam 28 in each case is advantageously guided through a hole 42 that is closest to the current machining area 24. In addition, the measurement is advantageously carried out on the top side 64 of the second workpiece 14 in the vicinity of the corresponding hole 42, so that paired measuring points are close to one another and close to a gap 34 that may possibly be present.

The holes 42, 44, 46 may then be welded closed when the current machining area 24 is appropriately advanced. The holes 42, 44, 46 are thus present only for the control measurement, whereas a finished part is provided without the holes 42, 44, 46.

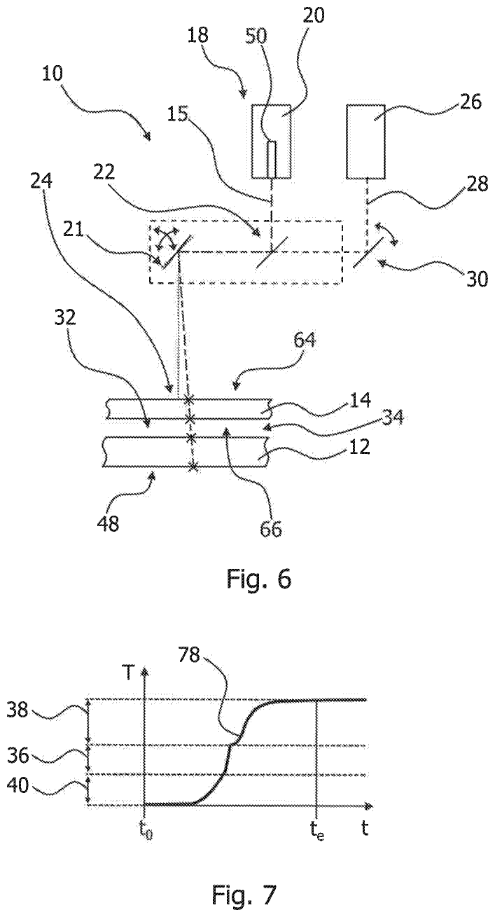

FIG. 6 illustrates a further aspect, in which test machining of the workpiece 12, 14 that is different from the machining of the workpieces 12, 14 takes place during the control measurement. For this purpose, the machining beam 15 is briefly moved forward, out of the current machining area 24, and thus follows the course illustrated by dash-dotted lines in FIG. 6, and not the course for machining the current machining area 24, which is illustrated by the dotted line. The deflection angle is typically much smaller than schematically illustrated in FIG. 6. By means of the machining beam 15, the test machining takes place in such a way that material is melted through both workpieces 12, 14, and the bottom side 48 of the first workpiece 12 is penetrated at certain points.

During the control measurement, the measuring beam 28 is displaced in such a way that it coincides with the machining beam 15 and/or enters a keyhole of the test machining. A temporal depth profile 78 for the test machining may thus be created within the scope of the control measurement. Such an OCT depth measurement profile 78 is schematically illustrated in FIG. 7, which depicts the machining depth T, measured by OCT measurement, as a function of the machining time t. The test machining begins at a point in time t₀, at which the machining beam 15 is directed onto the top side 64 of the second workpiece 14, and ends at a point in time tₑ. At the start, the material of the second workpiece 14 melts in an impingement area, with the machining depth initially undergoing little or no change. A keyhole then gradually forms in the second workpiece 14, and the machining beam 15 also penetrates into the first workpiece 12. In FIG. 6, characteristic points for the test machining process are marked by crosses situated on the top sides 32, 64 and bottom sides 48, 66 of the workpieces 12, 14. During the machining, a melt forms between the workpieces 12, 14 which may bridge the workpieces 12, 14, even in the presence of a gap 34. At least the point on the bottom side 66 of the second workpiece 14 and the point on the top side 32 of the first workpiece 12 may then possibly not be clearly identifiable in an OCT measurement. In addition, the temporal depth profile 78 in each case follows a different course, depending on the material composition, the thicknesses 38, 40 of the workpieces, the distance 36 between the workpieces 12, 14, parameters of the machining beam 15, and other machining parameters. Under certain circumstances, although this course may have the plateaus and jumps mentioned at the outset, the course often is not visible when the machining depth corresponds to the thickness 40 of the second workpiece 14, a sum of the thickness 40 of the second workpiece 14, and the distance 36 between the workpieces 12, 14, or additionally the thickness 38 of the first workpiece 12, in particular for the case of the mentioned bridging melt.

In contrast, the overall thickness of the superposed workpieces 12, 14 is apparent from the depth profile 78, since the point on the top side 64 of the second workpiece 14 as well as the point on the bottom side 48 of the first workpiece 12 are clearly represented. Even after a penetration on the bottom side 48 of the first workpiece 12, a portion of the measuring beam 28 is always reflected. However, this reflection takes place solely from areas within the superposed workpieces 12, 14. Therefore, a maximum penetration depth is measured that originates from the point on the bottom side 48 of the first workpiece. The sum of the thicknesses 38, 40 of the workpieces 12, 14 and the distance 36 between the workpieces 12, 14 may thus be reliably determined from the depth profile 78. This sum may in turn be compared to the sum of the known workpiece thicknesses 12, 14 in order to determine the distance 36 between the workpieces 12, 14 and deduce the presence of a gap 34.

Multiple test machinings may be carried out during the machining, so that the presence or the course of the gap 34 may be determined. In addition, these test machining points may be welded closed during the subsequent machining of the workpieces 12, 14.

In the case shown, the machining device 18 has a switchable fiber 50 by means of which the diameter of the machining beam 15 may be changed. A large diameter is used for machining the workpieces 12, 14, while a small diameter is used for the test machining. The bottom side 48 of the first workpiece 12 is therefore penetrated only in a small area, and a corrosion protection layer is damaged only to a negligible extent.

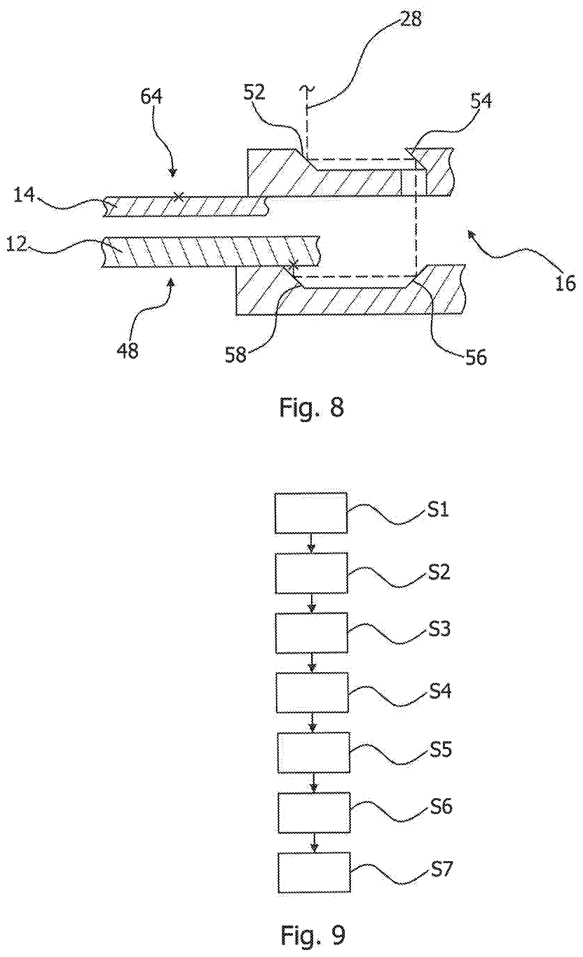

FIG. 8 shows a workpiece holder 16 according to one aspect of the invention, which is provided with reflective elements 52, 54, 56, 58. Within the scope of the control measurement, the measuring beam 28 is directed onto the reflective elements 52, 54, 56, 58 in such a way that a measurement may be carried out on the bottom side 48 of the first workpiece 12. The measurement in question is carried out in an inserted and positioned state of the workpieces 12, 14. This measurement may in turn be combined with a measurement on the top side 64 of the second workpiece 14. This is schematically illustrated by the measuring points marked by crosses in FIG. 8.

The reflective elements 52, 54, 56, 58 may include polished surfaces, mirrors, or other suitable reflective elements. In addition, at least one of the reflective elements 52, 54, 56, 58 may be movable and/or pivotable, thus allowing deflection of the measuring beam 28 in an adjustable manner.

Alternatively, a measurement on the bottom side 48 of the first workpiece 12 is carried out by means of a further optical coherent tomograph (not illustrated).

In addition, it is also possible according to the invention to provide the first workpiece 12 with holes and/or notches through which the measuring beam may be guided onto the bottom side 66 of the second workpiece 14. This may be carried out by means of the workpiece holder 16 with reflective elements 52, 54, 56, 58 and/or by means of a further optical coherent tomograph. The above-described control measurements through the second workpiece 14 onto the top side 32 of the first workpiece 12 may similarly take place on the bottom side 66 of the second workpiece 14. In addition, a measurement is carried out on the bottom side 48 of the first workpiece 12. A distance between corresponding measuring points may then be compared to the known thickness 40 of the first workpiece 12 in order to determine the distance 36 between the workpieces 12, 14 and/or deduce the presence of a gap 34.

In principle, for the described measuring points it is possible for them to correspond to the points onto which the measuring beam 28 is directed. However, it is also possible to direct the measuring beam 28 onto some other point, wherein this point and the corresponding measuring point lie in a shared plane that is parallel to a main plane of extension of the workpieces 12, 14. It is then possible, for example, to determine a distance along a surface normal of the workpieces 12, 14, even when points that are offset relative to one another perpendicularly with respect to the surface normal are measured.

FIG. 9 shows a schematic flow chart of a method for carrying out and monitoring a machining process of the workpieces 12, 14. The method is carried out by means of the device 10.

The first workpiece 12 is inserted into the workpiece holder 16 in a first step S1 of the method.

The second workpiece 14 is positioned in the target position on the top side 32 of the first workpiece 12 in a second step S2 of the method.

The high-energy machining beam 15 is provided and projected and/or focused on the current machining area 24 in a third step S3 of the method.

The measuring beam 28 is generated in the optical coherent tomograph in a fourth step S4 of the method, the measuring beam 28 being deflected via the movable deflection unit and at least temporarily coupled into the machining beam 15.

A process measurement is carried out in the current machining area 24, during the machining of the workpieces 12, 14, by means of the measuring beam 28 in a fifth step S5 of the method.

A control measurement is carried out by means of the measuring beam 28 in a sixth step S6.

The distance 36 between the workpieces 12, 14 is determined in a seventh step S7, based on the result of the control measurement, for detecting a gap 24 that is possibly present between the workpieces 12, 14.

Different aspects of the method have also been described in conjunction with the device 10. This also results in further steps or substeps of the method.

What is claimed is:

1. A method for carrying out and monitoring a machining process of a first workpiece and a second workpiece for joining the first and second workpieces using a high-energy machining beam, wherein the method comprises the steps:
inserting the first workpiece into a workpiece holder;
positioning the second workpiece on a top side of the first workpiece at a target position for joining the workpieces;
providing a high-energy machining beam that has an optical axis, and projecting the machining beam on a current machining area;
generating a measuring beam in at least one optical coherent tomograph, the measuring beam being coupleable into the machining beam;
carrying out a process measurement using the measuring beam in the current machining area during machining of the workpieces using the machining beam;
carrying out a control measurement using the measuring beam on at least a portion of at least one of the workpieces; and
determining a distance between the first workpiece and the second workpiece for detecting a gap that is possibly present between the workpieces, based on the result of the control measurement.

2. The method according to claim 1, wherein the process measurement and the control measurement are carried out by the same coherent tomograph.

3. The method according to claim 1, comprising the further step:
carrying out the control measurement, using the optical coherent tomograph, at least in part during the machining of the workpieces.

4. The method according to claim 1, wherein a predefined thickness of the first workpiece and a predefined thickness of the second workpiece are used for determining the distance between the first workpiece and the second workpiece.

5. The method according to claim 1, wherein the control measurement includes at least one determination of the position of the workpiece holder, the control measurement being carried out, at least in part, before the first workpiece is inserted.

6. The method according to claim 1, wherein the control measurement includes at least one measurement on the top side of the first workpiece in a state in which the second workpiece is at the target position.

7. The method according to claim 6, wherein for at least a portion of the control measurement, on the top side of the first workpiece a measuring beam is at least partially guided through a hole in the second workpiece that is provided in the second workpiece independently of the machining of the workpieces.

8. The method according to claim 7, wherein the hole in the second workpiece is welded closed on the top side of the first workpiece after the measurement.

9. The method according to claim 1, wherein for the control measurement, at least one test machining of the workpieces that is different from the machining of the workpieces is carried out.

10. The method according to claim 9, wherein the test machining takes place through both workpieces in such a way that a bottom side of the first workpiece is penetrated at certain points.

11. The method according to claim 9, wherein after the test machining, an area in which the test machining has been carried out is welded closed using the machining beam.

12. The method according to claim 9, wherein the machining of the workpieces and the test machining are carried out using machining beams that have different beam diameters.

13. The method according to claim 12, wherein a switchable fiber is used for generating the machining beams for the test machining and for the machining of the workpieces.

14. The method according to claim 1, wherein for the control measurement, at least one measurement is carried out on a bottom side of the first workpiece.

15. The method according to claim 14, wherein for the measurement on the bottom side of the first workpiece, a measuring beam is deflected on at least a portion of the workpiece holder by use of a reflective element.

16. A device for carrying out and monitoring a machining process of a first workpiece and a second workpiece for joining the first and second workpieces using a high-energy machining beam, wherein the device comprises:
a workpiece holder into which at least the first workpiece is insertable;
a machining unit having a machining beam source for generating the high-energy machining beam, which has an optical axis, and including machining beam optics for projecting the high-energy machining beam on a current machining area, and
at least one optical coherent tomograph for generating a measuring beam that is coupleable into the machining beam optics,
wherein the device is configured:
in an inserted state of the first workpiece in which the second workpiece is positioned on a top side of the first workpiece at a target position for machining the workpieces, to carry out at least one process measurement using the measuring beam during machining of the workpieces using the machining beam;
to carry out a control measurement using the measuring beam on at least a portion of at least one of the workpieces; and
to determine a distance between the first workpiece and the second workpiece, based on the result of the control measurement, in order to detect a gap that is possibly present between the workpieces.

17. The device according to claim 16, wherein the machining unit has a switchable fiber through which a beam diameter of the machining beam may be changed.

18. The device according to claim 16, further including a control unit that is configured to determine the distance between the first workpiece and the second workpiece based on the result of the control measurement and based on a predefinable thickness of the first workpiece and a predefinable thickness of the second workpiece.

19. The device according to claim 16, wherein the workpiece holder includes at least one reflective element through which the measuring beam may be directed onto a bottom side of the first workpiece.

20. A method for manufacturing a workpiece for use in a method according to claim 1, which is configured to be joined to another workpiece along a joining seam using a high-energy machining beam, comprising the steps:
producing a workpiece blank; and
providing the workpiece blank with multiple holes along a course that a future joining seam is to follow.
